(19) United States
(12) Patent Application Publication
(10) Pub. No.: US 2006/0103742 A1
(43) Pub. Date: May 18, 2006

(54) Image capture apparatus and image capture method

(75) Inventors: Hiroaki Kubo, Muko-shi (JP); Ryuichi Kitaoka, Sakai-shi (JP)

Correspondence Address: SIDLEY AUSTIN LLP, 717 NORTH HARWOOD, SUITE 3400, DALLAS, TX, 75201, US

(73) Assignee: KONICA MINOLTA PHOTO IMAGING, INC.

(21) Appl. No.: 11/216,921

(22) Filed: Aug. 31, 2005

(30) Foreign Application Priority Data
Nov. 18, 2004 (JP) JP2004-334021

(51) Int. Cl. H04N 5/217

(52) U.S. Cl. 348/241

(57) ABSTRACT

For a V-line noise occurring in an image due to a defect in a VCCD of an image sensor, a position where a V-line noise is expected to occur when an image capture apparatus is in an initial state (initial noise position) is previously stored in a noise address memory. Then, a V-line noise is corrected by either using information about the initial noise position or detecting a position of the V-line noise, depending factors responsible for a temperature of the image sensor (a temperature of a substrate of the image sensor, a time period which has elapsed since the image capture apparatus was activated, and establishment or non-establishment of a continuous photographing mode), in other words, depending on a state of the image capture apparatus.

This application is based on application No. 2004-334021 filed in Japan, the contents of which are hereby incorporated by reference.

### BACKGROUND OF THE INVENTION

1. Field of the Invention

The present invention relates to an image capture apparatus.

2. Description of the Background Art

A CCD image sensor employed in a digital camera has become more compact and the number of pixels included therein has increased in recent years, which in turn invites increase in the number of defective pixels.

One technical solution to compensate for a defective pixel is to previously store data about an address of the defective pixel and specify the location of the defective pixel, as conventionally disclosed.

However, a defective pixel occurs also in a vertical transfer line for transferring signal charges in a CCD image sensor. As a result, a highly-bright linear noise (V-line noise) occurs in a captured image. The occurrence of such linear noise depends on temperature. Such linear noise cannot be corrected by the above-mentioned conventional processes in which the location of a defective pixel is specified and pixel interpolation is carried out.

### SUMMARY OF THE INVENTION

The present invention concerns an image capture apparatus.

According to one aspect of the present invention, an image capture apparatus includes: an image capturing part including an image sensor, for capturing an image of a subject as image data; a memory for storing positions of some linear noises occurring due to at least one defect in an electric-charge transfer line of the image sensor in the image of the subject captured by the image capturing part when the image capture apparatus is in an initial state; a noise position detector for detecting positions of one or more linear noises occurring due to the at least one defect in the electric-charge transfer line of the image sensor in the image of the subject captured by the image capturing part in photographing; a state detector for detecting a state of the image capture apparatus which affects a temperature regarding the image sensor in the photographing; and a noise corrector for selectively making one of: first correction in which the one or more linear noises are corrected using information about the positions of the some linear noises; and second correction in which the one or more linear noises are corrected using information about the positions of the one or more linear noises which are detected by the noise position detector, depending on the state of the image capture apparatus which is detected by the state detector.

Since a linear noise can be corrected taking into consideration temperature dependency of occurrence of linear noise, it is possible to obscure a linear noise, regardless of temperature.

According to another aspect of the present invention, an image capture apparatus includes: an image capturing part including an image sensor, for capturing an image of a subject as image data; a memory for previously storing data indicating relationships between positions of one or more linear noises occurring due to at least one defect in an electric-charge transfer line of the image sensor in the image of the subject and plural typical temperatures of the image sensor; a temperature detector for detecting a temperature regarding the image sensor in photographing; a noise position identifying part for identifying the positions of the one or more linear noises which are associated with the temperature which is detected by the temperature detector, based on the data; and a noise corrector for correcting the one or more linear noises in the image of the subject captured by the image capturing part in the photographing, using information about the positions of the one or more linear noises which are identified by the noise position identifying part.

Since a linear noise can be corrected taking into consideration temperature dependency of occurrence of linear noise, it is possible to obscure a linear noise, regardless of temperature.

The present invention also concerns an image capture method.

It is therefore an object of the present invention to provide a technique for obscuring a linear noise (V-line noise), regardless of temperature.

These and other objects, features, aspects and advantages of the present invention will become more apparent from the following detailed description of the present invention when taken in conjunction with the accompanying drawings.

### BRIEF DESCRIPTION OF THE DRAWINGS

FIGS. 1A, 1B, and 1C illustrate a principal structure of an image capture apparatus 1 according to a preferred embodiment of the present invention.

FIG. 2 is a functional block diagram of the image capture apparatus 1.

FIG. 3 illustrates a structure of an image sensor 16.

FIG. 4 is a view for explaining a V-line noise.

FIGS. 5 and 6 are views for explaining a principle of detection of V-line noise.

FIG. 7 is a flow chart for illustrating operations for detecting a V-line noise in the image capture apparatus 1.

FIGS. 8A, 8B, and 8C are views for explaining temperature dependency of V-line noise in the image sensor 16.

FIGS. 9, 10 and 11 are views for explaining correction of V-line noise by offsetting.

FIG. 12 is a flow chart for illustrating operations for obtaining a noise level of V-line noise in the image capture apparatus 1.

FIG. 13 is a view for explaining operations for correction of V-line noise by pixel interpolation.

FIG. 14 is a flow chart for illustrating correction of V-line noise, taking into consideration increase in a temperature.

FIG. 15 is a flow chart for illustrating operations for obtaining a noise level according to a modification of the present invention.

### DESCRIPTION OF THE PREFERRED EMBODIMENTS

<Structure of Image Capture Apparatus>

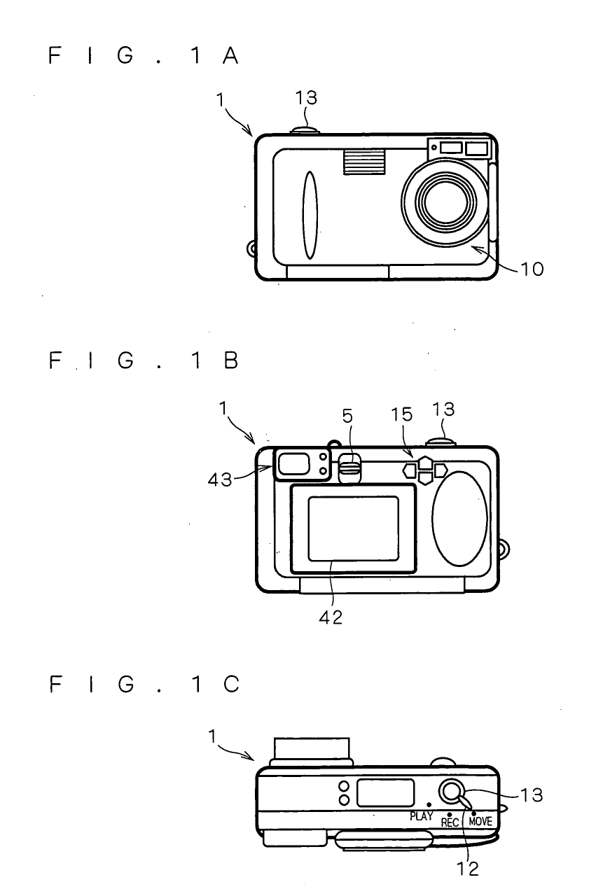

Referring to FIGS. 1A, 1B, and 1C, a structure of an image capture apparatus 1 will be described. FIG. 1A, 1B, and 1C are a front view, a back view, and a top view of the image capture apparatus 1, respectively.

The image capture apparatus 1 is configured to function as a digital camera, and includes a taking lens 10.

The image capture apparatus 1 further includes a mode selection switch 12 and a shutter start button 13 (referred as “shutter button” hereinafter) on a top face thereof.

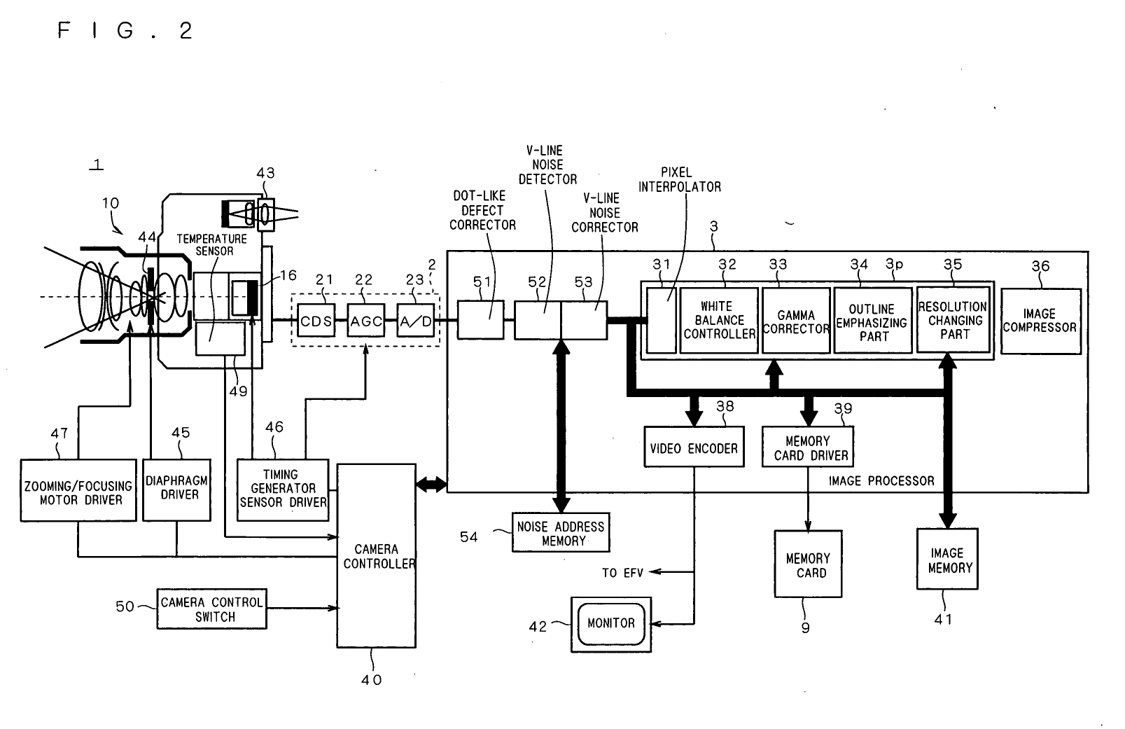

The mode selection switch 12 is a switch for selecting one of three modes of: a still-image capturing mode (REC mode) in which an image of a subject is captured and a captured still image of the subject is recorded; a moving-image capturing mode (MOVE mode) in which a moving image is captured; and a playback mode (PLAY mode) in which an image recorded in a memory card 9 (see FIG. 2) is played back.

The shutter button 13 is a two-position switch which can be placed in two detectable states of a state in which the shutter button 13 is halfway pressed down (an S1 state) and a state where the shutter button 13 is fully pressed down (an S2 state). Upon a halfway press of the shutter button 13 in the still-image capturing mode, a zooming/focusing motor driver 47 (see FIG. 2) is driven, and an operation for moving the taking lens 10 to an in-focus position is started. Further, upon a full press of the shutter button 13 in the still-image capturing mode, a main operation for photographing, i.e., an operation for capturing an image which is to be recorded, is started.

On a back face of the image capture apparatus 1, a liquid crystal display (LCD) monitor 42 for displaying a captured image and the like, an electronic view finder (EVF) 43, and a frame-advance/zooming switch 15, and a power switch 5 are provided.

The frame-advance/zooming switch 15 includes four buttons, and supplies instructions for performing frame-to-frame advance of recorded images in the playback mode, zooming in photographing, and the like. By operating the frame-advance/zooming switch 15, the zooming/focusing motor driver 47 illustrated in FIG. 2 is driven, so that a focal length of the taking lens 10 can be changed. Also, when the still-image capturing mode is selected, by pushing buttons provided on the right-hand side and the left-hand side of the frame-advance/zooming switch 15, it is possible to change a method for correcting a V-line noise (which will be later described). Further, the power switch 5 is used for making a change in a state of the image capture apparatus 1 between a state in which the image capture apparatus 1 is turned on (power-on state) and a state in which the image capture apparatus 1 is turned off (power-off state). The change in the state of the image capture apparatus 1 is accomplished by moving the power switch 5 upward and downward.

FIG. 2 is a functional block diagram of the image capture apparatus 1.

The image capture apparatus 1 includes an image sensor 16, a signal processor 2 connected to the image sensor 16 such that data can be transmitted therebetween, an image processor 3 connected to the signal processor 2, and a camera controller 40 connected to the image processor 3.

The image sensor 16 is configured to function as an area sensor (imaging device) in which primary-color transmitting filters for transmitting plural kinds of color components, red (R), green (G), and blue (B), are arranged on pixels, respectively, in a checkerboard pattern (Bayer pattern). The image sensor 16 is of a type in which data of all pixels thereof are simultaneously read out. A temperature of the image sensor 16 can be detected by a temperature sensor 49 for measuring a temperature inside of the image capture apparatus 1.

After exposure is performed and electric charges are stored in the image sensor 16, the electric charges in the form of signals obtained as a result of photoelectric conversion are shifted to vertical and horizontal transfer lines in the image sensor 16 which is shielded from light. Then, the signals are output as image signals from the vertical and horizontal transfer lines via a buffer. Thus, the image sensor 16 functions for capturing an image signal (image) of a subject.

The signal processor 2 includes a correlated double sampler (CDS) 21, an automatic gain controller (AGC) 22, and an A/D converter 23, and functions as what is called an analog front end.

After the image signal which is in an analog format is output from the image sensor 16, sampling is performed on the image signal in the CDS 21 so that a noise is eliminated. Subsequently, the image signal is multiplied by an analog gain corresponding to a sensitivity for photographing, by the AGC 22, to adjust the sensitivity.

The A/D converter 23 is configured to function as a 14-bit converter and digitizes the analog image signal which is normalized in the AGC 22. Then, predetermined image processing is performed on the digitized image signal in the image processor 3, so that image data (an image file) is created.

The image processor 3 includes a pixel defect corrector 51, a V-line noise detector 52, and a V-line noise corrector 53. The image processor 3 further includes a digital processor 3p, an image compressor 36, a video encoder 38, and a memory card driver 39.

In the image processor 3 to which the image data is input, first, data of each defective pixel is substituted by correction data based on an address of each pixel defect which is previously stored in the pixel defect corrector 51. Subsequently, a linear noise (which will be hereinafter referred to as a “V-line noise”) occurring in an image due to a defect in the vertical transfer line (vertical CCD) of the image sensor 16 is detected and corrected in the V-line noise detector 52 and the V-line noise corrector 53 (, details of which will be later provided). An address (i.e., position) of each noise which is detected by the V-line noise detector 52 is stored in a noise address memory 54.

The digital processor 3p includes a pixel interpolator 31, a white balance controller 32, a gamma corrector 33, an outline emphasizing part 34, and a resolution changing part 35.

The image data is input to the digital processor 3p, and then written into an image memory 41 in synchronization with readout in the image sensor 16. Thereafter, the image data in the image memory 41 is accessed each time processing is performed on the image data by the digital processor 3p.

First, gain control is performed on each of R pixels, G pixels, and B pixels of the image data in the image memory 41, independently of one another, in the white balance controller 32, to achieve white balance control of the R pixels, G pixels, and B pixels. In order to achieve white balance control, a portion which is supposed to be white by nature in a photographed subject is estimated from data about brightness, chromaticness, and the like, to determine respective average pixel values of R pixels, G pixels, and B pixels, a G/R ratio, and a G/B ratio of that portion. Then, the amount of gain for gain control of the R pixels and the B pixels is determined based on the resultant values and ratios, to achieve white balance control.

After white balance control is performed on the image data, the R pixels, the G pixels, and the B pixels of the image data are masked by respective filter patterns in the pixel interpolator 31, and pixel interpolation is performed. For interpolation of G color, a spatial change in pixel value is estimated based on contrast patterns of twelve G pixels surrounding a pixel being attended, and an optimal pixel value for a pattern of a subject is calculated based on data of four G pixels surrounding the pixel being attended and is given to the pixel being attended, because variation in pixel value at the G pixels is relatively great. On the other hand, interpolation of R color or B color is accomplished based on pixel values of eight same-color (R or B) pixels surrounding a pixel being attended.

After the image data is subjected to pixel interpolation, non-linear conversion, in particular, gamma correction and offset adjustment, is performed on the image data in the gamma corrector 33, in order to make the image data compatible with each of output devices, and then, the image data is stored in the image memory 41.

The outline emphasizing part 34 emphasizes an outline of the image using a high pass filter conforming to the image data, or the like.

Then, horizontal and vertical contraction or thinning out is performed on the image data stored in the image memory 41 by the resolution changing part 35, so that the original number of pixels of the image data is changed to the predetermined number of pixels. Subsequently, the image data is subjected to image compression in the image compressor 36, and recorded in the memory card 9 placed in the memory card driver 39. Thus, each image recorded in the memory card 9 is controlled to have the predetermined resolution. Further, the resolution changing part 35 performs pixel thinning out also at the time of displaying an image, to create a low resolution image which is to be displayed on the LCD monitor 42 or the EVF 43. At the time of preview, a low resolution image with 640×240 pixels which is read out from the image memory 41 is encoded in accordance with NTSC/PAL standards by the video encoder 38, and playback of image is achieved in the LCD monitor 42 or the EVF 43 by using the low resolution image as a field.

The camera controller 40 includes a CPU and a memory, and functions to comprehensively control respective parts of the image capture apparatus 1. More specifically, the camera controller 40 processes an input which is made by a photographer to a camera control switch 50 including the mode selection switch 12, the shutter button 13, the frame-advance/zooming switch 15, the power switch 5, and the like. Specifically, the camera controller 40 functions to select one of the still-image capturing mode for capturing an image of a subject and recording image data of the subject, the moving-image capturing mode, and the playback mode, in response to an operation performed on the mode selection switch 12 by a photographer. Also, the camera controller 40 functions to select one of various photographing modes including a mode in which a plurality of frames of images are continuously captured (continuous photographing mode), a portrait mode, a sports mode, and the like, in response to an operation performed on the frame-advance/zooming switch 15 by a photographer. Further, the camera controller 40 turns on and off the image capture apparatus 1 in response to an operation performed on the power switch 5 by a photographer.

Still further, the camera controller 40 determines whether or not the continuous photographing mode is selected, in order to change the method for correcting a V-line noise (described later). Moreover, the camera controller 40 measures how much time has elapsed since the power of the image capture apparatus 1 was on to activate the image capture apparatus 1, or receives information from the temperature sensor 49, to thereby detect a temperature regarding the image sensor 16.

When the image capture apparatus 1 is in a preparation state prior to the main operation for photographing, preview display (live view display) for displaying a subject on the LCD monitor 42 in a motion image manner is provided. During the preview display, an aperture of a diaphragm 44 is maximized by a diaphragm driver 45. Also, charge storage time (exposure time) of the image sensor 16 which corresponds to a shutter speed (SS) is included in exposure control data. The exposure control data is calculated by the camera controller 40 based on live view images captured in the image sensor 16. Then, feedback control on a timing generator sensor driver 46 is exercised in accordance with a program chart which is previously set based on the calculated exposure control data, in order to obtain a proper exposure time for the image sensor 16.

Then, during the main operation for photographing, an amount of light exposure of the image sensor 16 is controlled by the diaphragm driver 45 and the timing generator sensor driver 46 in accordance with a program chart which is previously set based on data about an amount of light obtained through light-metering during the live view display.

The image capture apparatus 1 including the above-described structure is capable of detecting and correcting a V-line noise in image data captured by the image sensor 16. Below, detection and correction of V-line noise will be described in detail.

<Detection of V-Line Noise>

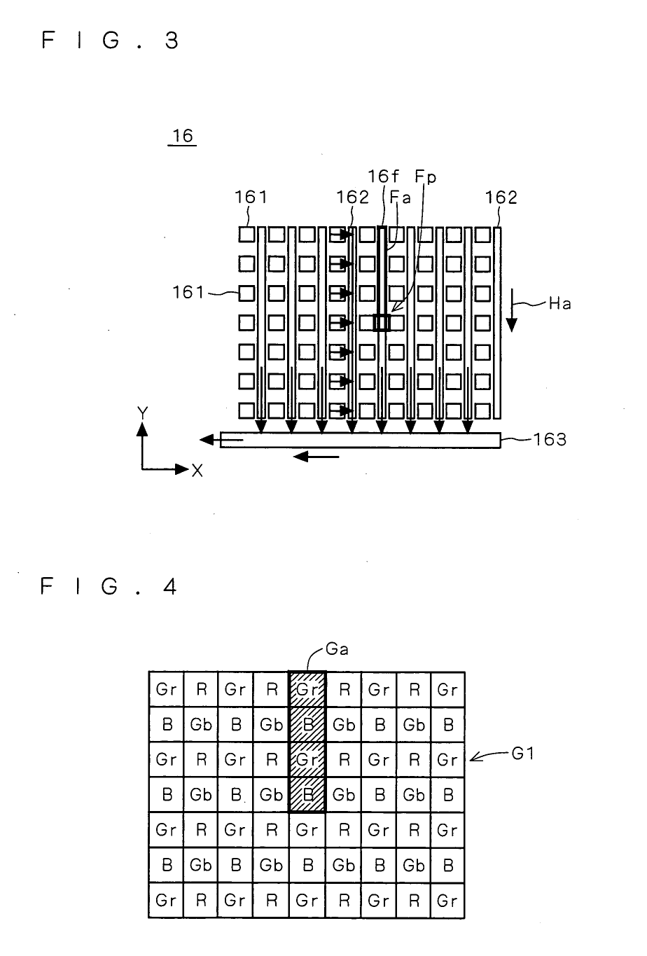

FIG. 3 illustrates a structure of the image sensor 16.

In the image sensor 16, electric charges which have been subjected to photoelectric conversion and stored in photodiodes 161 are read out by vertical CCDs 162 (which will be also referred to as “VCCDs”) respectively placed on the vertical transfer lines, and transferred to a horizontal CCD 163 placed at the lowest level in the image sensor 16 in a cycle of a period required for transferring electric charges on one horizontal pixel array (“horizontal transferring period”). Then, the electric charges transferred to the horizontal CCD 163 are read out in accordance with pixel clocks, so that readout in a horizontal direction can be achieved. It is additionally noted that the lines used for transferring electric charges, such as the VCCDs 162 and the horizontal CCD 163, will be also collectively referred to as “electric-charge transfer lines”).

By the foregoing operations in the image sensor 16, a two-dimensional image captured in the photodiodes 161 which are two-dimensionally arranged is read out, per horizontal pixel array.

Now, in a case where the photodiodes 161 include a defect, electric charges generated due to the defect are added to signal charges, so that a pixel defect appears in a captured image. To compensate for the pixel defect, the pixel defect corrector 51 subtracts a pixel level corresponding to the additional electric charges generated due to the defect.

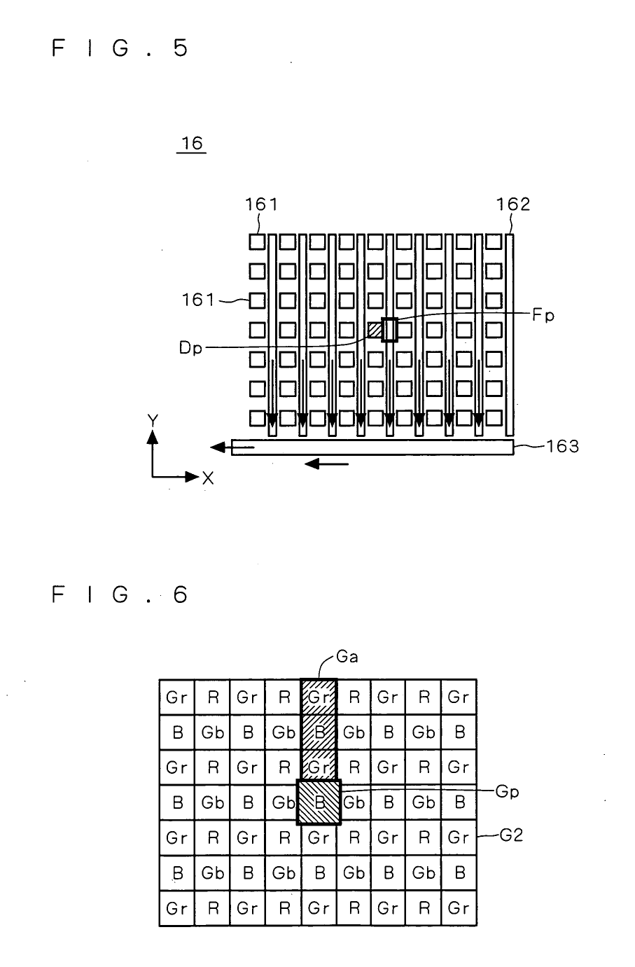

On the other hand, in a case where the vertical transfer lines include a defective portion Fp, electric charges supplied from some of the photodiodes 161 at the same address in an X direction as one of the photodiodes 161 on which readout of electric charge is performed by the defective portion Fp are output from the image sensor 16, having passed through a vertical CCD 16f in which the defective portion Fp exists. Accordingly, extra electric charges are added to a pack of signal charges (“signal charge pack”) Fa transferred from portions located upstream of the defective portion Fp in a direction of charge transfer (“charge transfer direction”) Ha. As a result, a highly-bright linear noise (V-line noise) Ga appears in a captured image G1, as illustrated in FIG. 4.

In the first-described case in which the photodiodes 161 include a defect to cause a pixel defect in a captured image, there are involved not so many factors responsible for degradation in quality of the captured image. To the contrary, the V-line noise Ga as illustrated in FIG. 4 significantly affects the quality of the captured image. Hence, it is important to detect a V-line noise. A method for detecting a V-line noise will be described in detail as follows.

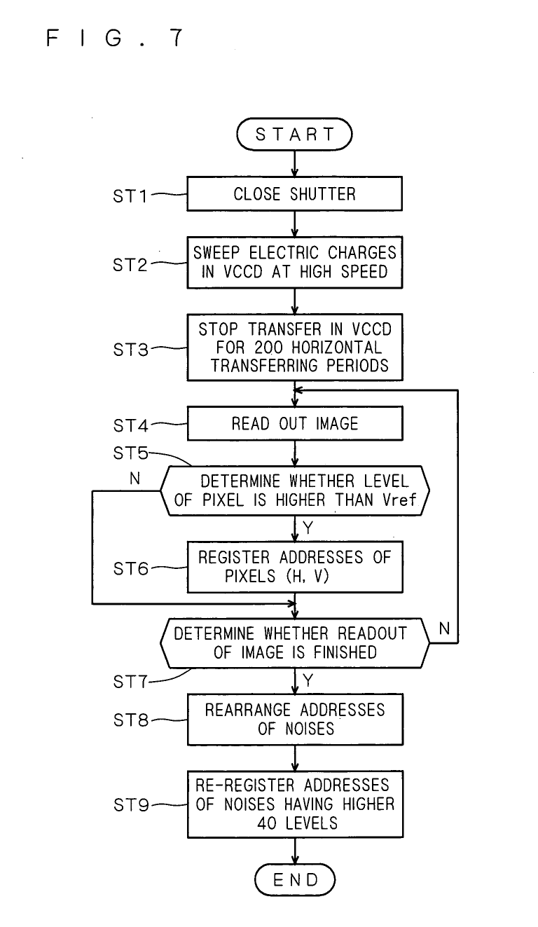

FIGS. 5 and 6 are views for explaining a principle of detection of V-line noise.

The V-line noise Ga (see FIG. 4) is a highly-bright linear noise occurring in an image due to the signal charge pack Fa which has been read out through the defective portion Fp of the vertical CCDs 162 illustrated in FIG. 3, as described above.

For detection of the V-line noise Ga, the vertical CCDs 162 are stopped from transferring electric charges during a given time period (200 horizontal transferring periods, for example), as illustrated in FIG. 5. As a result, an amount of electric charges generated in the defective portion Fp is increased. Thereafter, vertical transfer is performed without transferring the electric charges from the photodiodes 161 to the VCCDs 162. In this manner, the electric charges can be output from the image sensor 16 as if data of a pixel of a photodiode Dp from which electric charges is read out by the defective portion Fp in the vertical CCDs 162 being emphasized to form an image G2 illustrated in FIG. 6.

The image G2 is an image formed by electric charges accumulated by the VCCDs 162. As a result, within the image G2, a pixel level of a B pixel Gp which is included in the V-line noise Ga and corresponds to the photodiode Dp (see FIG. 5) on which readout of electric charges is performed by the defective portion Fp is increased in proportion to the time period during which the vertical CCDs 162 are stopped from transferring electric charges.

After the image G2 as described above is read out, an address of the pixel Gp serving as a highly-bright luminescent spot in the image G2 is detected, so that a position (address) of a defective portion at the bottom of the V-line noise Ga is detected. More specific description about detection of V-line noise in the image capture apparatus 1 will be provided as below.

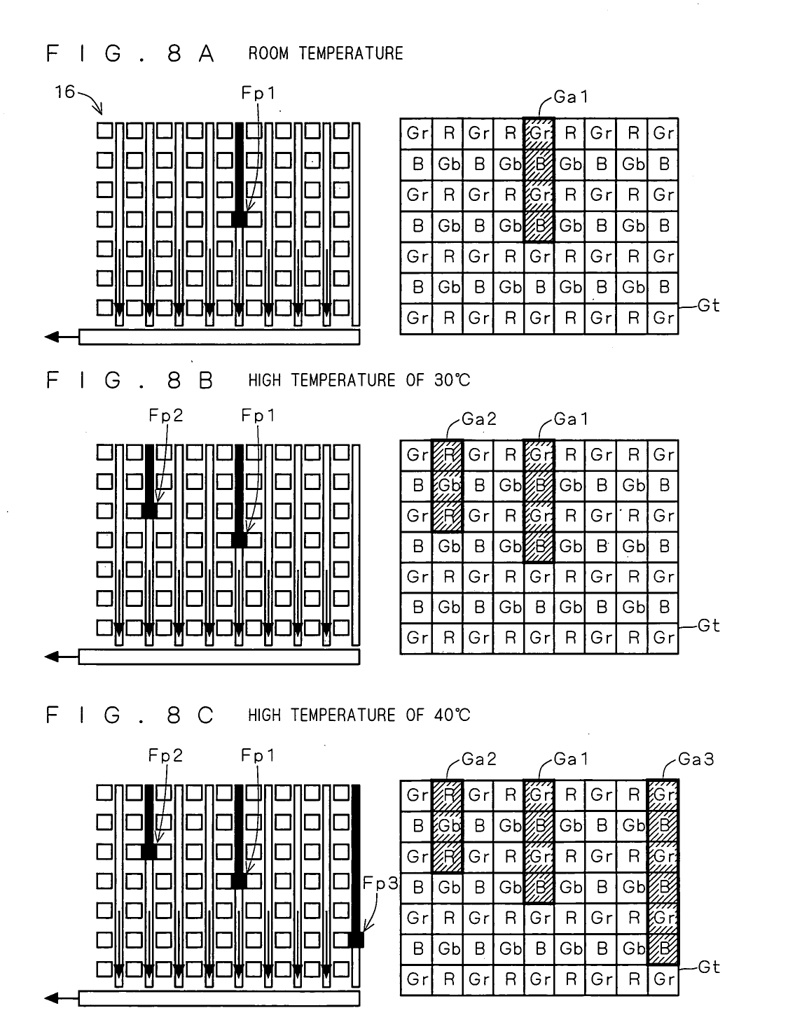

FIG. 7 is a flow chart for illustrating operations for detecting a V-line noise in the image capture apparatus 1.

First, the diaphragm 44 functionally corresponding to a shutter is closed (step ST1), and subsequently, high speed sweeping of electric charges is initiated in the VCCDs 162 (step ST2).

In a step ST3, the VCCDs 162 are stopped from transferring electric charges for 200 horizontal transferring periods as described above. As a result, an amount of electric charges in a defective portion in the VCCDs 162 is increased.

In a step ST4, plural pieces of data of the respective pixels (“pixel data”) are sequentially read out from the image sensor 16 while no electric charge is transferred from the photodiodes to the VCCDs.

In a step ST5, determination as to whether or not a normalized value of a level of each of the pieces of the pixel data read out in the step ST4, which is obtained by multiplying the level of the pixel data by 1/200, is larger than a predetermined reference noise level (threshold value) Vref which defines tolerance is made. If the normalized value of the level of the pixel data is larger than the reference noise level Vref, the process flow goes to a step ST6. On the other hand, if the normalized value of the level of the pixel data is equal to or smaller than the reference noise level Vref, the process flow goes to a step ST7.

In the step ST6, an address (H, V) on an image of each defective pixel (noise) which provides a piece of data having a level larger than the reference noise level Vref is registered in the noise address memory 54. At the same time, also a noise level (pixel value) of each defective pixel is registered.

In the step ST7, determination as to whether or not readout of an image from the image sensor 16 is finished. If it is determined that readout of image is finished, the process flow goes to a step ST8. If it is determined that readout of image is not finished, the process flow goes back to the step ST4.

In the step ST8, addresses of some of all the registered are rearranged. For example, the addresses are rearranged in order of noise level, i.e., in a descending order.

In a step ST9, addresses of noises, levels of which fall within higher 40, in other words, top 40, are re-registered, together with the 40 top-ranked noise levels, in the noise address memory 54, by referring to the addresses of all the registered noises which are rearranged in the step ST8. As to the levels of noises, normalized values each obtained by multiplying the level of a piece of the pixel data which is read out when transfer of electric charges is stopped for 200 horizontal transferring periods by 1/200 are re-registered.

By the above-described operations of the image capture apparatus 1, a V-line noise can be appropriately detected. The above-described operations for detection are performed at a controlled predetermined temperature prior to factory shipment of the image capture apparatus 1, for example. Thus, the image capture apparatus 1 is shipped from a factory with necessary information being stored as default data in the noise address memory 54.

It is additionally noted that in the step ST8, the addresses of the noises may be rearranged based on not only the noise levels of V-line noises but also extents of V-line noises. For example, the addresses of the noises may be rearranged based on information derived from values obtained by respectively multiplying the noise levels by the extents of V-line noises. This allows rearrangement of the addresses of noises taking into consideration influences of each V-line noise on an entire image.

A V-line noise in the image sensor 16 depends on a temperature. Below, the temperature dependency of V-line noise will be described.

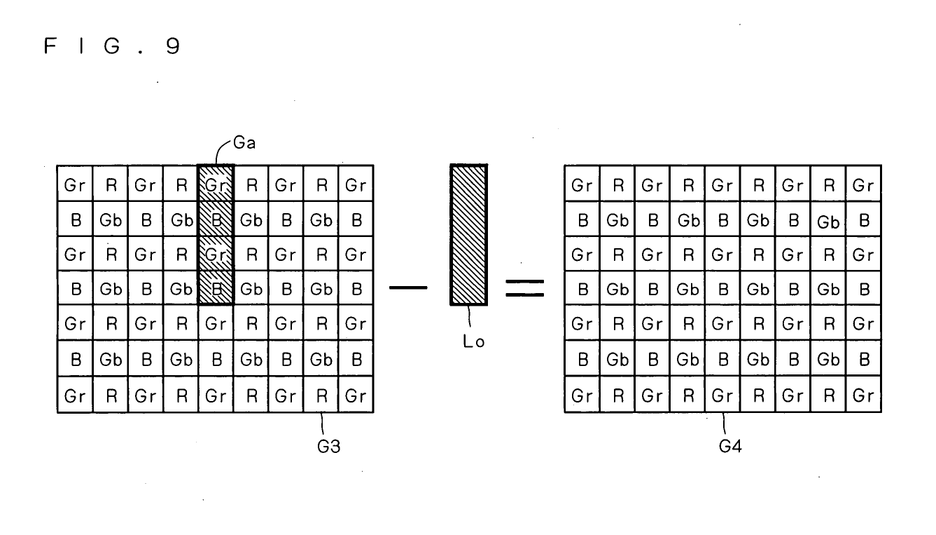

FIGS. 8A, 8B, and 8C are views for explaining the temperature dependency of V-line noise in the image sensor 16. FIGS. 8A, 8B, and 8C show examples of states of the image sensor 16 which is maintained at a room temperature (20 degrees centigrade, for example), a higher temperature of 30 degrees centigrade, and a much higher temperature of 40 degrees centigrade, respectively, and also show images Gt output from the image sensor 16 in the respective states.

When the image sensor 16 is maintained at a room temperature, one defective portion Fp1 which causes a noise beyond the tolerance is observed in the vertical CCDs as shown in FIG. 8A. Accordingly, only one V-line noise Ga1 is caused in the image Gt output from the image sensor 16.

When the image sensor 16 is maintained at a high temperature of 30 degrees centigrade, the number of revealed V-line noises is increased because of the higher temperature, so that the number of revealed V-line noise is larger than that in the image output from the image sensor 16 which is maintained at a room temperature. Specifically, when the image sensor 16 is maintained at a temperature of 30 degrees centigrade, defective portions Fp1 and Fp2 each of which causes a noise beyond the tolerance are observed in the vertical CCDs as shown in FIG. 8B. Accordingly, V-line noises Ga1 and Ga2 are caused in the image Gt output from the image sensor 16.

When the image sensor 16 is maintained at a much higher temperature of 40 degrees centigrade, the number of revealed V-line noises is increased because of the much high temperature, so that the number of revealed V-line noise is larger than that in the image output from the image sensor 16 which is maintained at a temperature of 30 degrees centigrade. Specifically, when the image sensor 16 is maintained at a temperature of 40 degrees centigrade, defective portions Fp1, Fp2, and Fp3 each of which causes a noise beyond the tolerance are observed in the vertical CCDs as shown in FIG. 8C. Accordingly, V-line noises Ga1, Ga2, and Ga3 are caused in the image Gt output from the image sensor 16.

As is made clear from the foregoing, a V-line noise in the image sensor 16 depends on a temperature. Hence, it is preferable to perform the above-described operations for detection of V-line noise at each of typical temperatures.

<Correction of V-Line Noise>

The V-line noise corrector 53 of the image capture apparatus 1 is configured to be capable of selectively employing one of two methods for correcting a detected V-line noise. In (1) one of the two methods, correction is achieved by offsetting. In (2) the other of the two methods, correction is achieved by pixel interpolation. Those two methods will be described as follows.

(1) Correction by Offsetting

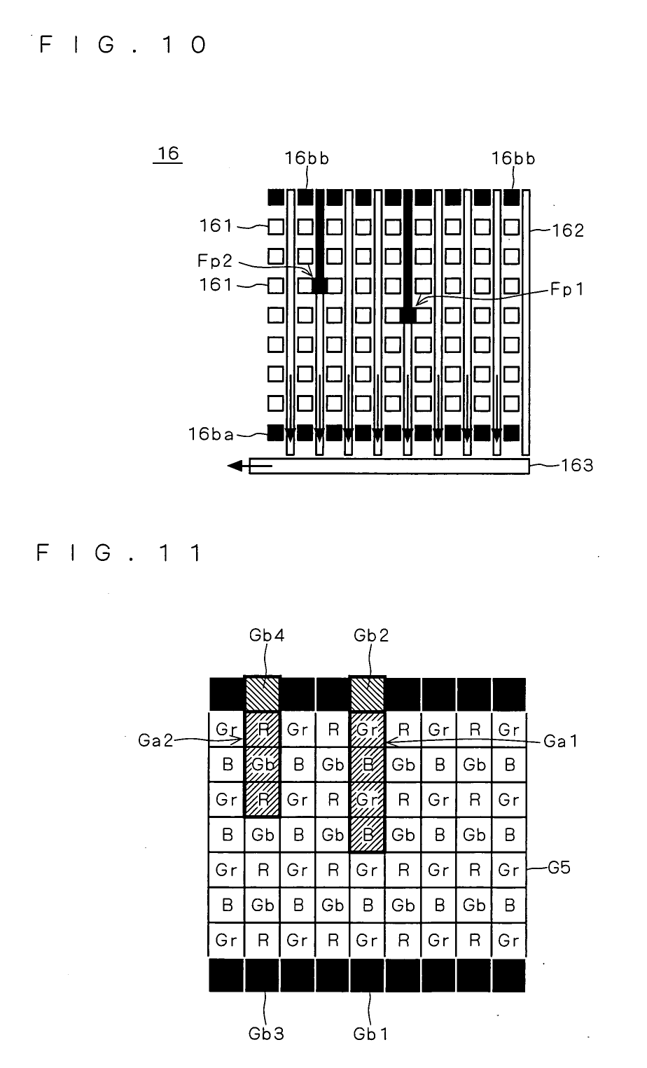

FIG. 9 is a view for explaining correction of V-line noise by offsetting.

In the correction of V-line noise by offsetting, first, a component which is caused due to the V-line noise Ga and is to be offset (“offset component”) Lo in an image G3 output from the image sensor 16 is detected. Subsequently, the offset component Lo (a level of the V-line noise) is subtracted from a pixel level of the V-line noise Ga in the image G3, to create a corrected image G4 from which an image noise is removed.

In the method for correcting a V-line noise by offsetting, correction may be made by estimating a noise level (offset component Lo) based on the default data about V-line noises which is stored in the noise address memory 54 before the factory shipment of the image capture apparatus 1, as described above. However, considering the characteristics of V-line noise which greatly depends on a temperature, it is preferable to determine a value which is to be offset (“offset value” or “correction value”) in real time at the time of photographing. The offset value is obtained at the time of photographing by the following processes.

The image sensor 16 includes optical black parts (which will be hereinafter referred to as “OB parts”) 16ba and 16bb shielded from light for detecting a black level as illustrated in FIG. 10. Out of electric charges read out from the vertical CCDs 162, electric charges read out from the OB part 16ba located at a lower level relative to the OB part 16bb are transferred to the horizontal CCD 163, ahead of electric charges read out from the OB part 16bb located at an upper level relative to the OB part 16ba. In the following, the processes for obtaining an offset value will be described by taking a case where two defective portions Fp1 and Fp2 are included in the vertical CCDs 162, as an example.

Referring to FIG. 11, in an image G5 output from the image sensor 16, a pixel level of a pixel Gb2 which is read out from the upper OB part 16bb, passes through the defective portion Fp1 in the vertical CCDs 162, and is accordingly affected by the defective portion Fp1, is higher by the offset value than a pixel level of a pixel Gb1 which is read out from the lower OB part 16ba, does not passes through the defective portion Fp1, and is not affected by the defective portion Fp1. Also, a pixel level of a pixel Gb4 which is read out from the upper OB part 16bb and passes through the defective portion Fp2 in the vertical CCDs 162 is higher by the offset value than a pixel level of a pixel Gb3 which does not passes through the defective portion Fp2.

Accordingly, the level (offset value) of the V-line noise Ga1 illustrated in FIG. 11 is obtained by subtracting the pixel level of the pixel Gb1 from the pixel level of the pixel Gb2. Also, the offset value of the V-line noise Ga2 is obtained by subtracting the pixel level of the pixel Gb3 from the pixel level of the pixel Gb4.

Next, operations for obtaining the offset value (noise level) in the image capture apparatus 1 will be described in detail.

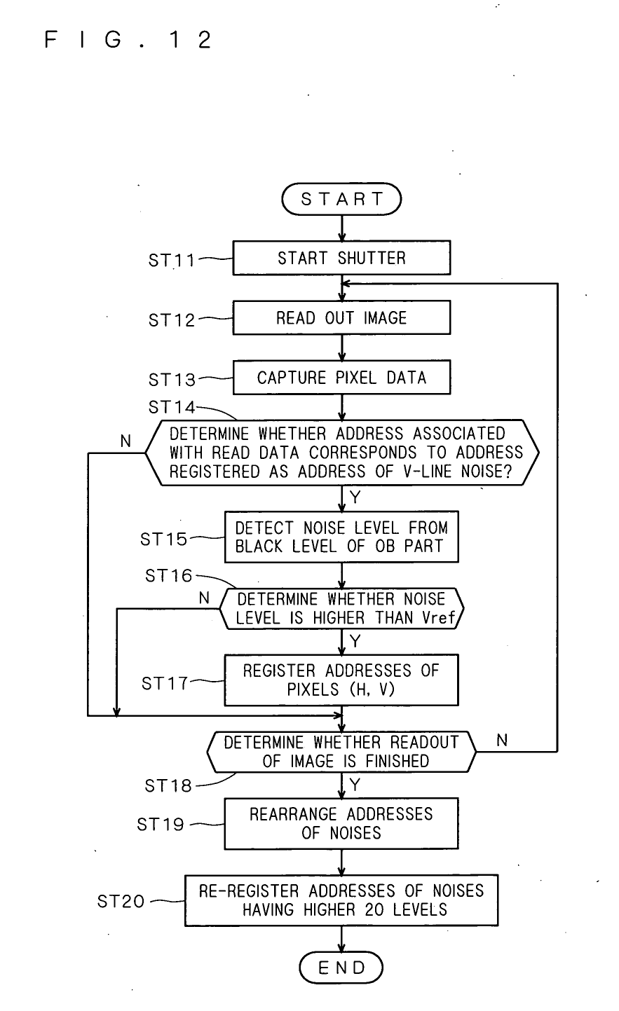

FIG. 12 is a flow chart for illustrating the operations for obtaining the noise level of V-line noise in the image capture apparatus 1.

In a step ST11, the shutter function is started to perform exposure. More specifically, the shutter button 13 is fully pressed down (in other words, placed in the S2 state) by a photographer, to photograph a subject:

In a step ST12, plural pieces of pixel data are sequentially read out from the image sensor 16.

In a step ST13, the plural pieces of pixel data read out from the image sensor 16 in the step ST12 are captured.

In a step ST14, determination as to whether or not each of respective addresses of pixels which provides the pixel data read out in the step ST12 corresponds to any of the addresses of V-line noises registered in the noise address memory 54 is made. If any of the addresses of the pixels corresponds to one address registered in the noise address memory 54, the process flow goes to a step ST 15. On the other hand, if no address corresponds to any of the addresses registered in the noise address memory 54, the process flow goes to a step ST18.

In the step ST15, respective black levels of the OB parts 16ba and 16bb (see FIG. 10) placed at opposite ends of the vertical CCDs 162 to which the plural pieces of pixel data read out in the step ST12 are transferred are detected, and a difference between the black levels is calculated, to obtain a noise level.

In a step ST16, determination as to whether or not the noise level obtained in the step ST15 is higher than the reference noise level Vref. If the detected noise level is higher than the reference noise level Vref, the process flow goes to a step ST17. On the other hand, if the detected noise level is equal to or lower than the reference noise level Vref, the process flow goes to the step ST18.

In the step ST17, an address (H, V) on an image of each defective pixel (noise) having the noise level which is determined to be higher than the reference noise level Vref in the step ST16 is registered in the noise address memory 54. Also the noise level of each defective pixel is registered at the same time.

In the step ST18 and a step ST19, the same operations as in the step ST7 and the step ST8 in the flow chart of FIG. 7 are performed, respectively.

In a step ST20, addresses of some of all the registered noises, levels of which fall within higher 20, in other words, top 20, are re-registered, together with the 20 top-ranked noise levels, in the noise address memory 54, by referring to the addresses of all the registered noises which are rearranged in the step ST19.

By the above-described operations of the image capture apparatus 1, it is possible to obtain a noise level at the time of photographing, so that correction of V-line noise by offsetting can be properly accomplished.

Additionally, by previously storing information about each V-line noise which is detected at a temperature within a predetermined range prior to factory shipment, it is possible to achieve higher speed correction with the use of the information in the noise address memory 54.

(2) Correction by Pixel Interpolation

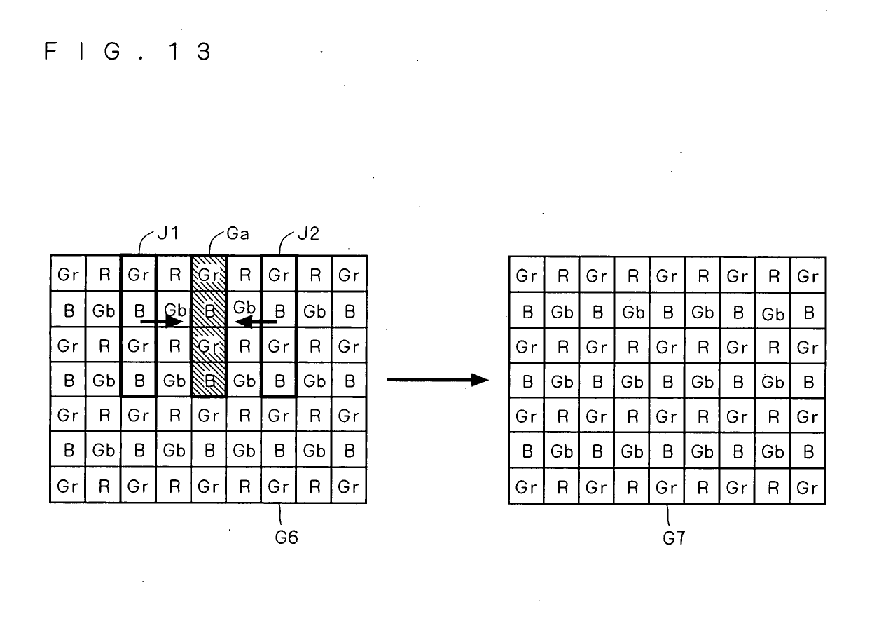

FIG. 13 is a view for explaining correction of V-line noise by pixel interpolation.

In correction of V-line noise by pixel interpolation, substitute data is created based on data about lines each formed of some pixels (“pixel line”) located around a V-line noise, and pixel data of the V-line noise is substituted by the substitute data.

For example, in an image G6 illustrated in FIG. 13, two pixel lines J1 and J2 which are of the same color as the V-line noise Ga and located on right and left sides of the V-line noise Ga are detected. Then, pixel data of the V-line noise is substituted by an average value of pixel levels of the pixel lines J1 and J2. As a result, a corrected image G7 from which a noise is removed is created.

The correction of V-line noise by pixel interpolation may suffer from lower accuracy as compared to the correction of V-line noise by offsetting. However, in a situation where the location (address) of V-line noise is previously known, there is no need of obtaining a noise level in the correction of V-line noise by pixel interpolation. Also, basically, there is no need of taking into consideration temperature characteristics of the offset value of a V-line noise.

<Countermeasures for Temperature Dependency of V-Line Noise>

As described above, a V-line noise is suppressed by either (1) the correction by offsetting or (2) the correction by pixel interpolation. However, occurrence of V-line noise in the image sensor 16 depends on a temperature as explained above with reference to FIGS. 8A, 8B, and 8C.

For this reason, it is necessary to take into consideration factors of increase in a temperature of the image sensor 16, in detecting a position of V-line noise (noise address) at the time of photographing, or obtaining a noise level which is to be offset in a case where the correction by offsetting is performed. However, this requires a long time period for image processing of one frame of image, to reduce the number of images which can be captured per unit time period, resulting in degraded performance in repetitive photographing.

In view of the foregoing, the image capture apparatus 1 according to the present embodiment changes the method for correction of V-line noise as needed, drawing attention to a fact that the temperature of the image sensor 16 gradually increases from the temperature at the time of activation of the image capture apparatus 1.

More specifically, addresses and levels of V-line noises which are observed when the image capture apparatus 1 is activated are previously detected and stored as default data in the noise address memory 54. Then, at the time of actual photographing, if the image capture apparatus 1 has been just activated or if the image capture apparatus 1 is determined to be placed in the same state as a state at the time of activations a V-line noise is corrected based on the default data without detecting an address or a level of the V-line noise. On the other hand, if the image capture apparatus 1 has not just been activated, or if the image capture apparatus 1 is determined to be placed in a state different from a state at the time of activation, an address or a level of a V-line noise is detected at the time of photographing, to correct the V-line noise.

A state of the image capture apparatus 1 which has been put within a predetermined time period (short time) from the time when being activated can be assumed to be equivalent to the state immediately after being activated. A state of the image capture apparatus 1 is therefore assumed to be an initial state as long as within the predetermined time period, even if the image capture apparatus 1 has not been just activated.

Therefore, for the default data, data stored in the noise address memory 54, which data is derived from the image capture apparatus 1 which has been just activated or have been put for a predetermined time period from the time when the image capture apparatus 1 was activated, at a certain controlled temperature, prior to factory shipment of the image capture apparatus 1, is employed as explained above with reference to FIG. 7. In the meantime, in the present specification, a state of the image capture apparatus 1 which has been just activated or have been put for a predetermined time period from the time when the image capture apparatus 1 was activated, will be also referred to as an “initial state”. Further, a position of V-line noise occurring in the initial state will be also referred to as an “initial noise position”.

Below, operations for changing the method for correction of V-line noise which takes into consideration factors responsible for increase in a temperature of the image sensor 16 will be described. The following description will be made, assuming that the correction of V-line noise by offsetting out of the two methods for correction of V-line noise is performed, unless otherwise indicated.

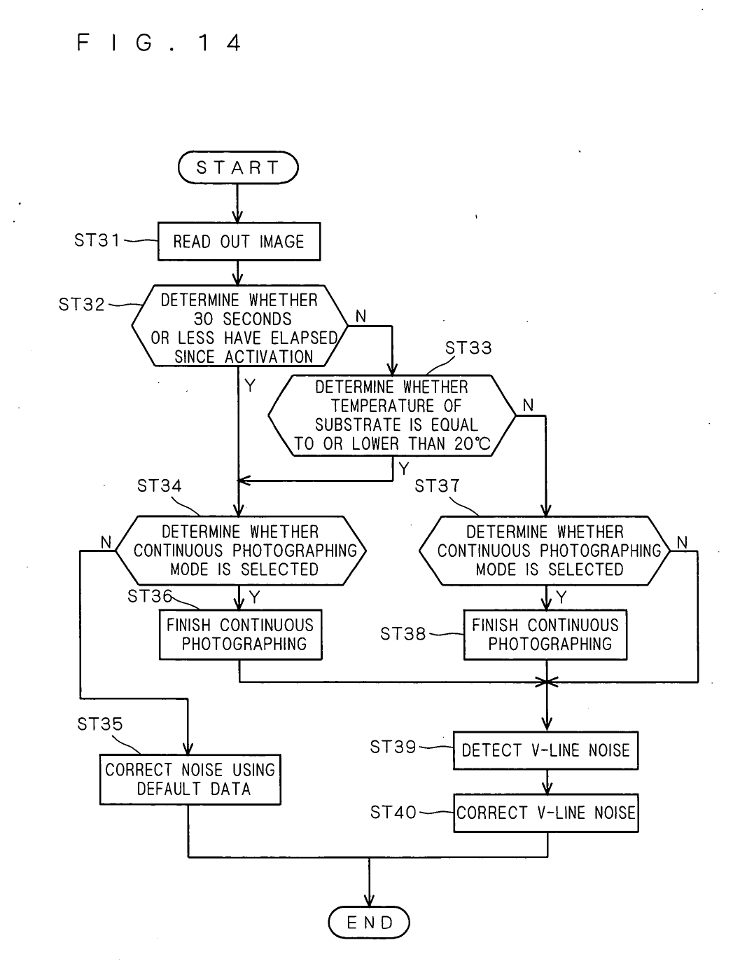

FIG. 14 is a flow chart illustrating operations for correcting a V-line noise, including processes for changing the method for correction of V-line noise, taking into consideration factors responsible for increase in a temperature of the image sensor 16. The operations in the flow chart of FIG. 14 are controlled by the camera controller 40. In the process flow, a first step ST31 is started after the shutter button 13 is fully pressed down (in other words, is put in the S2 state) by a photographer so that a subject is photographed.

In the step ST31, plural pieces of pixel data are sequentially read out from the image sensor 16.

In a step ST32, determination as to whether or not 30 seconds (generally, a predetermined time period) have elapsed since the image capture apparatus 1 was activated is made. If it is determined that 30 seconds or less have elapsed since the image capture apparatus 1 was activated, the process flow goes to a step ST34. On the other hand, if it is determined that more than 30 seconds have elapsed, the process flow goes to a step ST33.

In the step ST33, determination as to whether or not a temperature of a substrate of the image sensor 16 which is detected by the temperature sensor 49 is equal to or lower than 20 degrees centigrade is made. If it is determined that the detected temperature is equal to or lower than 20 degrees centigrade, the process flow goes to the step ST34. On the other hand, if it is determined that the detected temperature is higher than 20 degrees centigrade, the process flow goes to a step ST37.

In the step ST34, determination as to whether or not the image capture apparatus 1 is placed in the continuous photographing mode is made. If it is determined that the image capture apparatus 1 is placed in the continuous photographing mode, the process flow goes to a step ST36. On the other hand, if it is determined that the image capture apparatus 1 is not placed in the continuous photographing mode, the process flow goes to a step ST35.

In the step ST35, a V-line noise in an image formed of the plural pieces of pixel data read out in the step ST31 is corrected using the default data stored in the noise address memory 54. Then, the process flow ends.

As described above, under conditions that 30 seconds or less have elapsed since the image capture apparatus 1 was activated or the temperature of the substrate of the image sensor 16 is equal to or lower than 20 degrees centigrade, and the image capture apparatus 1 is not placed in the continuous photographing mode, the image capture apparatus 1 is regarded as being in the initial state based on an empirical rule that under the foregoing conditions, the temperature of the substrate of the image sensor 16 does not substantially increase from the temperature at the time of activation of the image capture apparatus 1. Thus, a V-line noise is corrected by using the default data. Additionally, the above description has been made assuming that the continuous photographing mode is prepared as one option. However, in a case where no mode for continuous photographing is prepared, a V-line noise may be corrected by using the default data under the conditions that 30 seconds or less have elapsed since the image capture apparatus 1 was activated or the temperature of the substrate of the image sensor 16 is equal to or smaller than 20 degrees centigrade.

In the meantime, in a case where a V-line noise is corrected by the above-described pixel interpolation, a position of the V-line noise is specified based on an address of the V-line noise which is indicated by the default data, to thereby correct the V-line noise.

Turning back to the process flow, in the step ST36, plural frames of images are captured while they are sequentially stored in the image memory 41, to finish continuous photographing. Thereafter, the process flow goes to a step ST39.

In the step ST37, determination as to whether or not the image capture apparatus 1 is placed in the continuous photographing mode is made in the same manner as in the step ST34. If it is determined that the image capture apparatus 1 is placed in the continuous photographing mode, the process flow goes to a step ST38. On the other hand, if it is determined that the image capture apparatus 1 is not placed in the continuous photographing mode, the process flow goes to the step ST39.

In the step ST38, plural frames of images are captured while they are sequentially stored in the image memory 41, to finish continuous photographing, in the same manner as in the step ST36. Thereafter, the process flow goes to the step ST39.

In the step ST39, if the process flow comes from the step ST37, a position and a level of V-line noise in a captured image are detected by performing the same steps for detecting a V-line noise which are illustrated in FIG. 7.

On the other hand, if the process flow comes from the step ST 36 or the step ST38, a position and a level of V-line noise in the last frame of image out of the plural frames of images captured by continuous photographing are detected by performing the same steps for detecting a V-line noise which are illustrated in FIG. 7. Further, the detected position and level of V-line noise are stored in the noise address memory 54.

In the meantime, in a case where a V-line noise is corrected by the above-described pixel interpolation, only a position of V-line noise is detected without detecting a level of V-line noise.

In a step ST40, a V-line noise in an image stored in the image memory 41 is corrected by offsetting using information about the position and the level of V-line noise which are detected in the step ST39. Then, the process flow ends.

Additionally, in a case where plural frames of images captured by continuous photographing are stored in the image memory 41, a V-line noise in each of all the plural frames of images stored in the image memory 41 is corrected by offsetting using information about the position and the level of V-line noise which are detected in the step ST39.

A V-line noise in each of all the frames which are captured by continuous photographing is corrected using the position and the level of a V-line noise in the last frame of image out of all the images captured by continuous photographing, because of a fact that the temperature of the substrate of the image sensor 16 increases due to continuous photographing. Additionally, in a case where a V-line noise is corrected by the above-described pixel interpolation, a position of the V-line noise is specified based on the position of V-line noise which is detected in the step ST39, to thereby correct the V-line noise.

As is made clear from the above description, a position of V-line noise occurring when the image capture apparatus 1 is placed in the initial state (initial noise position) is previously stored in the noise address memory 54, for a V-line noise which is to occur in an image due to a defect in the VCCDs 162 of the image sensor 16, in the image capture apparatus. Then, the V-line noise is corrected by either using information about the initial noise position or detecting a position of the V-line noise, depending on factors responsible for the temperature regarding the image sensor 16 (the temperature of the substrate of the image sensor 16, a time period which has elapsed since the image capture apparatus 1 was activated, establishment or non-establishment of the continuous photographing mode and so on), in other words, depending on the state of the image capture apparatus 1. This makes it possible to correct a V-line noise taking into consideration temperature dependency of occurrence of V-line noise. As a result, a V-line noise can be obscured, regardless of temperature.

Also, the factors responsible for the temperature regarding the image sensor 16 (in other words, the state of the image capture apparatus 1) can be detected by at least one of: determination as to whether or not the continuous photographing mode is selected; measurement of a time period which has elapsed since the image capture apparatus 1 was activated; and detection of the temperature regarding the image sensor 16 by the temperature sensor 49.

In the image capture apparatus 1, under the conditions that the predetermined time period has not elapsed since the image capture apparatus 1 was activated or the temperature of the image sensor 16 is equal to or lower than 20 degrees centigrade, a V-line noise is corrected using information about the initial noise position, as described above. This makes it possible to correct a V-line noise without detecting the V-line noise, using the fact that the temperature regarding the image sensor 16 does not substantially increase from the temperature at the time of activation of the image capture apparatus 1. Accordingly, a time required for detection of V-line noise can be saved. As a result, when the image capture apparatus 1 is in the initial state or a state which can be regarded as being identical to the initial state, or when photographing is performed in cold climates, there is no need of detecting a V-line noise. Thus, a time period required for capturing and recording an image in photographing can be shortened, to thereby improve performance in repetitive photographing.

Also, when the image capture apparatus 1 is placed in the continuous photographing mode, respective V-line noises in plural frames of images captured by continuous photographing are corrected using information about a position of a V-line noise which is detected after continuous photographing. This makes it possible to properly correct a V-line noise occurring due to increase in the temperature of the image sensor 16 during continuous photographing.

<Modifications>

Hereinbefore, the preferred embodiment of the present invention has been described. However, the present invention is not limited to the above-described preferred embodiment.

According to the above-described preferred embodiment, correction of V-line noise is accomplished by using the default data under the condition that the image capture apparatus 1 is in the initial state or a state which can be regarded as being identical to the initial state. However, for example, respective relationships between changes in the temperature of the image sensor 16 and positions where a V-line noise is expected to occur are previously grasped prior to factory shipment of the image capture apparatus 1, and the relationships are stored as default data in the noise address memory 54. In actually photographing, the image capture apparatus 1 identifies a position where a V-line noise is supposed to occur by referring to one of the positions in the default data which is associated with an actual temperature regarding the image sensor 16. Then, correction of V-line noise can be accomplished by specifying a position of V-line noise based on the identified position.

More specifically, prior to factory shipment of the image capture apparatus 1, the image sensor 16 is controlled to be maintained at different temperatures of a room temperature (20 degrees centigrade, for example), 30 degrees centigrade, and 40 degrees centigrade, for example. Subsequently, respective positions of V-line noises which occur at the different temperatures are stored in association with the different temperatures in the noise address memory 54, as the default data. Thereafter, an actual temperature of the image sensor 16 is detected using the temperature sensor 49 immediately after pixel data is captured in photographing. If the temperature of the image sensor 16 is lower than 30 degrees centigrade, for example, a position where a V-line noise is supposed to actually occur is identified by referring to one of the positions in the default data which is associated with the room temperature. Then, correction of V-line noise is accomplished by specifying the position where a V-line noise is supposed to actually occur using information about the identified position. On the other hand, if the detected temperature of the image sensor 16 is equal to or higher than 30 degrees centigrade and lower than 40 degrees centigrade, a position where a V-line noise is supposed to actually occur is identified by referring to another of the positions in the default data which is associated with the temperature of 30 degrees centigrade. Then, correction of V-line noise is accomplished by specifying the position where a V-line noise is supposed to actually occur using information about the identified position. Further, if the detected temperature of the image sensor 16 is equal to or higher than 40 degrees centigrade, a position where a V-line noise is supposed to actually occur is identified by referring to another different one of the positions in the default data which is associated with the temperature of 40 degrees centigrade. Then, correction of V-line noise is accomplished by specifying the position where a V-line noise is supposed to actually occur using information about the identified position.

Additionally, in this modification, in a case where correction of V-line noise is accomplished by offsetting, respective levels of V-line noises are further stored in association with the positions of V-line noises in the noise address memory 54, as the default data. In this manner, correction of V-line noise can be achieved by using information about one of the positions and one of the levels in the default data which are associated with the detected temperature regarding the image sensor 16.

Also this modification makes it possible to correct a V-line noise taking into consideration temperature dependency of occurrence of V-line noise. As a result, a V-line noise can be obscured, regardless of temperature.

Further, according to the above-described preferred embodiment, the method for correcting a V-line noise is changed depending on whether or not the image capture apparatus 1 is in the initial state or a state which can be regarded as being identical to the initial state. However, the present invention is not limited to the preferred embodiment. For example, while photographing is once performed, a V-line noise is corrected by detecting a position or the like of the V-line noise. At that time, the detected position or the like of the V-line noise and the temperature detected by the temperature sensor 49 are stored in association with each other in the noise address memory 54, as reference data. Then, for next photographing, if the temperature of the image sensor 16 which is detected by the temperature sensor 49 is substantially equal to the temperature of the image sensor 16 which is included in the reference data stored in the noise address memory 54 in the former photographing, correction of V-line noise is accomplished by using information about the position or the like of V-line noise in the reference data stored in the noise address memory 54.

For more general purposes, not only a relationship between actual temperature regarding the image sensor 16 and a position of occurrence of V-line noise, but also a relationship between each of various states of the image capture apparatus 1 which affect the temperature of the image sensor 16 and a V-line noise, such as a relationship between a time period which has elapsed since the image capture apparatus 1 was activated and a position of occurrence of V-line noise, is stored in the noise address memory 54. If a state of the image capture apparatus 1 at the time of actual use corresponds to one of the states stored in the noise address memory 54, a position or the like of V-line noise can be identified by referring to one of the positions in the noise address memory 54 which is associated with the one state. Then, correction of V-line noise can be accomplished by using information about the identified position or the like of V-line noise.

Also this further modification makes it possible to correct a V-line noise taking into consideration temperature dependency of occurrence of V-line noise. As a result, a V-line noise can be obscured, regardless of temperature. Further, the number of times when detection of a position or the like of V-line noise must be performed is reduced, so that a time period required for detection of V-line noise can be minimized. As a result, a time period required for capturing and recording an image in photographing can be shortened, to thereby improve performance in repetitive photographing.

Still further, in a case where it has been already confirmed that a V-line noise hardly occurs when the temperature of the substrate of the image sensor 16 is equal to or lower than a predetermined temperature (10 degrees centigrade, for example), detection and correction of V-line noise are not necessarily required to be performed if a temperature equal to or lower than the predetermined temperature is detected as the temperature of the substrate of the image sensor 16 by the temperature sensor 49.

Even still further, according to the above-described preferred embodiment, it is determined whether or not the image capture apparatus 1 is in the initial state or a state which can be regarded as being identical to the initial state, depending on whether or not 30 seconds have elapsed since the image capture apparatus 1 was activated. However, for example, in an image capture apparatus of a type that employs an optical viewfinder so that an image sensor is not driven prior to a main operation for photographing, i.e., an operation for capturing an image, a V-line noise may be corrected using default data even after 30 seconds have elapsed since the image capture apparatus 1 was activated, with the image capture apparatus 1 being regarded as being in the initial state.

Moreover, according to the above-described preferred embodiment, a V-line noise is always detected and then corrected after continuous photographing is finished when the continuous photographing mode is selected. However, for example, under condition that 30 seconds or less have elapsed since the image capture apparatus 1 was activated or the temperature of the image sensor 16 is equal to or lower than 20 degrees centigrade, information used for correction of V-line noise may be changed depending on the number of frames of images captured in the continuous photographing mode. Specifically, when the number of frames of images captured by continuous photographing is smaller than a predetermined number of frames, a V-line noise in each of all the images captured by continuous photographing is corrected by using a position of V-line noise which is included in default data. On the other hand, when the number of frames of images captured by continuous photographing is equal to or larger than the predetermined number of frames, a V-line noise in each of all the images captured by continuous photographing is corrected by detecting a position of V-line noise which occurs in the last frame out of all the frames of images captured by continuous photographing after continuous photographing.

Moreover, a noise level (offset value) which is to be obtained at the time of photographing according to the above-described preferred embodiment may alternatively be obtained by processes similar to the processes for obtaining a noise level prior to factory shipment (see FIG. 7). Below, the alternative processes for obtaining a noise level will be described.

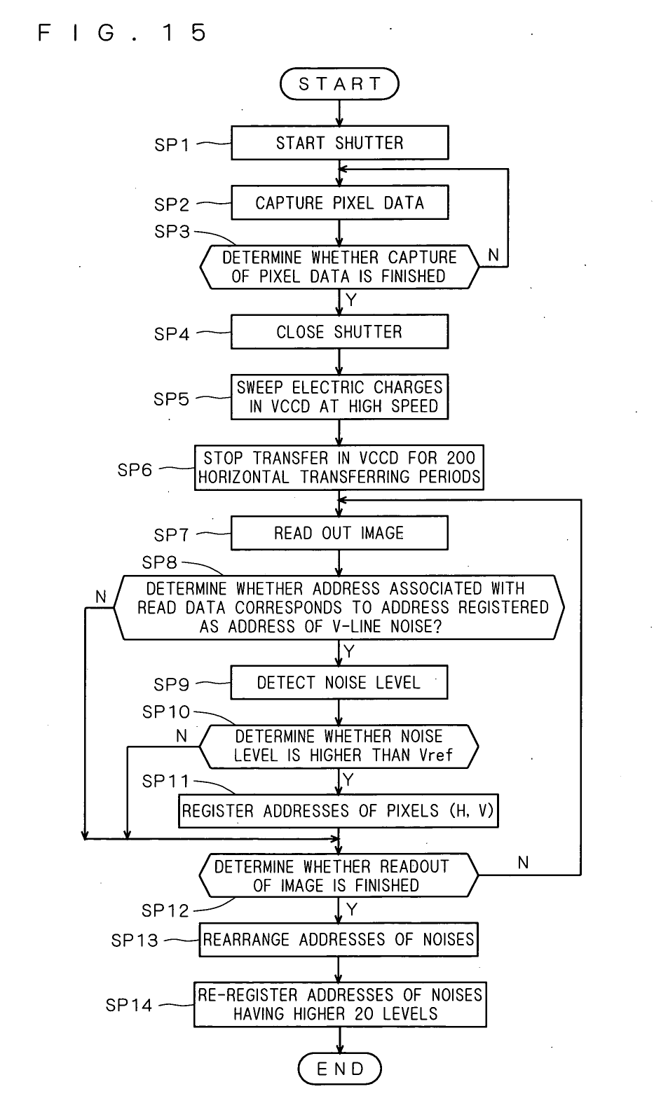

FIG. 15 is a flow chart for illustrating operations for obtaining a noise level according to a modification of the present invention.

In a step SP1 and a step SP2, operations similar to the operations performed in the steps ST11 and ST13 in FIG. 12 are performed, respectively.

In a step SP3, determination as to whether or not capture of pixel data is finished. When it is determined that capture of pixel data is finished, the process flow goes to a step SP4. On the other hand, when it is determined that capture of pixel data is not finished, the step SP2 is repeated.

In steps SP4, SP5, SP6, and SP7, operations similar to the operations performed in the steps ST1, ST2, ST3, and ST4 in FIG. 7 are performed, respectively.

In a step SP8, operations similar to the operations performed in the step ST14 in FIG. 12 are performed.

In a step SP9, a noise level is obtained. More specifically, a level of pixel data captured while stopping transfer of electric charges for 200 horizontal transferring periods is multiplied by 1/200 to normalize the level, which is then used as a noise level.

In steps SP10 to SP14, operations similar to the operations performed in the steps ST16 to ST20 in FIG. 12 are performed, respectively.

Also by the above-described operations, it is possible to properly obtain a noise level of V-line noise at the time of photographing.

Furthermore, according to the above-described preferred embodiment, a CCD of a type in which data of all pixels thereof are simultaneously read out is employed by way of example. However, a CCD of a type in which readout is accomplished one field by one field may alternatively be employed. In a case where such CCD is employed, by rearranging fields which have been read out so as to form one frame before correction of V-line noise, a V-line noise can be corrected in the same manner as in the above-described preferred embodiment.

While the invention has been shown and described in detail, the foregoing description is in all aspects illustrative and not restrictive. It is therefore understood that numerous modifications and variations can be devised without departing from the scope of the invention.

What is claimed is:

1. An image capture apparatus comprising:
an image capturing part including an image sensor, for capturing an image of a subject as image data;
a memory for storing positions of some linear noises occurring due to at least one defect in an electric-charge transfer line of said image sensor in said image of said subject captured by said image capturing part when said image capture apparatus is in an initial state;
a noise position detector for detecting positions of one or more linear noises occurring due to said at least one defect in said electric-charge transfer line of said image sensor in said image of said subject captured by said image capturing part in photographing;
a state detector for detecting a state of said image capture apparatus which has a relation to a temperature regarding said image sensor in said photographing; and
a noise corrector for selectively making one of: first correction in which said one or more linear noises are corrected using information about said positions of said some linear noises; and second correction in which said one or more linear noises are corrected using information about said positions of said one or more linear noises which are detected by said noise position detector, depending on said state of said image capture apparatus which is detected by said state detector.

2. The image capture apparatus according to claim 1, wherein
said state detector includes at least one of:
a mode selection detector for determining whether or not said image capture apparatus is placed in a continuous photographing mode in which plural images of said subject are continuously captured by said image capturing part;
a time measurement part for measuring how much time has elapsed since activation of said image capture apparatus; and
a temperature detector for detecting said temperature of said image sensor.

3. The image capture apparatus according to claim 1, wherein
when said state detector detects that a predetermined time period has not elapsed since activation of said image capture apparatus or that said temperature of said image sensor is equal to or lower than a predetermined temperature, said noise corrector corrects said one or more linear noises using said information about said positions of said some linear noises, in said photographing.

4. The image capture apparatus according to claim 1, wherein
when said state detector detects that said image capture apparatus is placed in a continuous photographing mode in which plural images of said subject are continuously captured by said image capturing part, said noise corrector corrects said one or more linear noises respectively occurring in said plural images of said subject which are captured by said image capturing part in continuous photographing for said photographing, using said information about said positions of said one or more linear noises which are detected by said noise position detector after said continuous photographing, in said photographing.

5. An image capture apparatus comprising:
an image capturing part including an image sensor, for capturing an image of a subject as image data;
a memory for previously storing data indicating relationships between positions of one or more linear noises occurring due to at least one defect in an electric-charge transfer line of said image sensor in said image of said subject and plural typical temperatures of said image sensor;
a temperature detector for detecting a temperature regarding said image sensor in photographing;
a noise position identifying part for identifying said positions of said one or more linear noises which are associated with said temperature which is detected by said temperature detector, based on said data; and
a noise corrector for correcting said one or more linear noises in said image of said subject captured by said image capturing part in said photographing, using information about said positions of said one or more linear noises which are identified by said noise position identifying part.

6. An image capture method performed by an image capture apparatus including an image capturing part which includes an image sensor and captures an image of a subject as image data, said method comprising the steps of:
(a) storing positions of some linear noises occurring due to at least one defect of an electric-charge transfer line of said image sensor in said image of said subject captured by said image capturing part when said image capture apparatus is in an initial state, in a preset memory;
(b) detecting a state of said image capture apparatus which has a relation to a temperature regarding said image sensor in photographing;
(c) selectively performing one of steps of: (i) correcting one or more linear noises occurring due to said at least one defect in said electric-charge transfer line of said image sensor in said image of said subject captured by said image capturing part by detecting positions of said one or more liner noises and using information about said positions of said one or more linear noises, in said photographing; and (ii) correcting said one or more linear noises using information about said positions of said some linear noises, depending on said state of said image capture apparatus which is detected in said step (b).

7. The image capture method according to claim 6, wherein
said state of said image capture apparatus includes at least one of:
establishment or non-establishment of a continuous photographing mode in which plural images of said subject are continuously captured by said image capturing part, in said image capture apparatus;
a time period which has elapsed since activation of said image capture apparatus; and
a temperature regarding said image sensor.

8. The image capture method according to claim 6, wherein
in said step (c), when it is detected in said step (b) that a predetermined time period has not elapsed since activation of said image capture apparatus or that said temperature regarding said image sensor is equal to or lower than a predetermined temperature, said one or more linear noises are corrected using said information about said positions of said some linear noises in said photographing.

9. The image capture method according to claim 6, wherein
in said step (c), when it is detected in said step (b) that said image capture apparatus is placed in a continuous photographing mode in which plural images of said subject are continuously captured by said image capturing part, said one or more linear noises respectively occurring in said plural images of said subject captured by said image capturing part in continuous photographing for said photographing are corrected by detecting said positions of said one or more linear noises after said continuous photographing and using said information about said positions of said one or more linear noises, in said photographing,

10. An image capture method comprising the steps of:
(e) previously storing data indicating relationships between positions of one or more linear noises occurring due to at least one defect in an electric-charge transfer line of an image sensor in an image of a subject captured by a preset image capturing part including said image sensor and plural typical temperatures regarding said image sensor, in a preset memory;
(f) detecting a temperature regarding said image sensor in photographing;
(g) identifying said positions of said one or more linear noises which are associated with said temperature regarding said image sensor which is detected in said step (f), based on said data; and
(h) correcting said one or more linear noises occurring in said image of said subject captured by said image capturing part in said photographing, using information about said positions of said one or more linear noises which are identified in said step (g).
